(19) United States
(12) Patent Application Publication
(10) Pub. No.: US 2018/0271627 A1
(43) Pub. Date: Sep. 27, 2018

(54) BALL-TYPE ATTACHMENT DEVICE FOR OVERDENTURES, AND METHOD OF PRODUCING OVERDENTURES TO WHICH BALL-TYPE ATTACHMENT IS APPLIED

(71) Applicant: KAINOS MEDENTECT INC., Seongnam-si (KR)

(72) Inventors: Dae Kyung LEE, Seongnam-si (KR); Hong Ki JEON, Yongin-si (KR)

(21) Appl. No.: 15/556,096

(22) PCT Filed: Nov. 13, 2015
(86) PCT No.: PCT/KR2015/012233

§ 371 Date: Sep. 6, 2017

(30) Foreign Application Priority Data
Mar. 10, 2015 (KR) 10-2015-0033273
Sep. 17, 2015 (KR) 10-2015-0131374
Oct. 8, 2015 (KR) 10-2015-0141775

(51) Int. Cl. A61C 8/00; A61C 13/265; A61C 13/34; A61C 13/00

(52) U.S. Cl. CPC A61C 8/0075; A61C 13/0028; A61C 13/34; A61C 13/2656

(57) ABSTRACT

Disclosed are a ball-type attachment device for an overdenture and and a method of producing overdenture to which ball-type attachments are applied. The ball-type attachment device for overdentures according to the present invention relates to an attachment device for implant-supporting overdenture, which includes an abutment configured such that a ball-shaped coupling protrusion is formed at the exposed distal end thereof, and a retainer configured to be separably fitted over the coupling protrusion by a fitting method. The retainer includes: a cushion part made of an elastically deformable material, and configured such that a coupling recession having a shape corresponding to the ball shape of the coupling protrusion is formed so as to allow the coupling protrusion to be separably inserted and fitted into the cushion part; and a fastening part configured to be fastened to the overdenture, and configured such that an accommodation recession configured to accommodate the cushion part is formed so as to allow the cushion part to be inserted and fitted into the fastening part.

### TECHNICAL FIELD

The present invention relates to an attachment device for an overdenture, and more specifically to a ball-type attachment device for an overdenture, in which the exposed distal end of an abutment is formed to a ball shape, and a method of producing an overdenture to which attachments are applied.

### BACKGROUND ART

An implantation procedure originally refers to a medical replacement procedure which recovers a tissue of a human body when the tissue is lost, and refers to a procedure which implants an artificial tooth root, i.e., the root of a tooth, in the field of dentistry. A dental implantation procedure is an advanced medical procedure which places an artificial tooth root made of titanium or the like, not generating an adverse reaction in a human body, in the portion of an alveolar bone from which a tooth has been lost in order to act as a substitute for the tooth root of the lost tooth and then attaches an artificial tooth thereto, thereby recovering the function of the tooth. Although a dental prosthesis or denture damages surrounding teeth and bones over time, an implant does not damage surrounding tooth tissues, has the same function and shape as a natural tooth, and is not prone to tooth decay, thereby providing the advantage of being used semi-permanently.

However, the dental implantation procedure is disadvantageous in that, since a number of teeth equal to the number of lost teeth are planted in principle, a high cost and a long period of time are required to replace a large number of lost teeth when the number of lost teeth is large, and is also disadvantageous in that it is difficult to apply the dental implantation procedure when the amount of remaining alveolar bone is insufficient.

Recently, in order to overcome the disadvantages of the dental implantation procedure, an implant-supported overdenture procedure (hereinafter referred to as “implant overdenture procedure”) has attracted great attention.

The implant overdenture procedure is a dental procedure which generally places two or more implants in the low jaw and four or more implants in the upper jaw and then separably fastens an overdenture by using various maintaining devices, such as bars, magnets, or the like. This implant overdenture procedure compensates for the disadvantage of a common denture procedure which does not provide sufficient maintaining and supporting force due to the absence of a structure capable of supporting masticatory force except for gums. The implant overdenture procedure has secured its position as an alternative to the high-cost dental implantation procedure in the case where the dental implantation procedure cannot be applied.

FIG. 1 is a perspective view showing an example of an implant-supported overdenture.

Referring to FIG. 1, a conventional implant-supported overdenture 20 may be generally supported by a plurality of implants placed in the gum part of a patient. A common implant may include a fixture (not shown) configured to be implanted into an alveolar bone of a patient, and an abutment 10 configured to be screwed into the upper portion of the fixture. Instead, a structure in which an abutment is integrated with a fixture may be provided. In this case, the abutment 10 is configured to be separably coupled to a cap-shaped retainer or retention device, and bonded and fastened to an overdenture 20 by adhesive resin or the like, upon wearing of the overdenture. When the maintenance of the overdenture 20 is required, a user can separate the overdenture 20 from the abutment 10 of the implant, and also the overdenture 20 can be mounted back on the abutment 10. In this case, the abutment 10 configured to be inserted into gums of a patient and the retainer bonded and fastened to the overdenture 20 are collectively referred to as an attachment device for an overdenture.

Meanwhile, bar-, magnet-, and ball joint-type attachments, etc. are known as methods of selectively mounting and demounting an overdenture on and from gums, i.e., methods of coupling and separating the exposed distal end of an abutment to and from a retainer, in an attachment device for an overdenture.

A conventional ball-type attachment device to which the ball joint-type one of the above attachments is applied generally includes an abutment configured to have a ball-shaped exposed distal end and a retainer configured to be fastened to an overdenture by adhesive resin or the like. In this case, the retainer includes a retainer body formed to have a space accommodating the exposed distal end of the abutment and made of a metallic material, and an O-ring configured to be mounted inside the retainer body and provide force maintaining coupling with the abutment. However, the conventional ball-type attachment device having the above-described configuration is a structure requiring the O-ring in order to maintain the coupling between the abutment and the retainer. Accordingly, the conventional ball-type attachment device is problematic in that the structure of the retainer is complex, and is also problematic in that interference attributable to the O-ring occurs in the process of inserting the exposed distal end of the abutment into the retainer, and thus it is difficult for the abutment and the retainer to be coupled to each other and maintained in various directions or at various angles. Furthermore, the conventional ball-type attachment device is problematic in that it is difficult to increase the diameter of the neck of the abutment due to the space occupied by the O-ring, and thus stress concentration on the neck increases and applied force cannot be stably transferred.

In order to overcome the above-described problems of the conventional ball-type attachment device, the present inventor developed a ball-type attachment device to which a retainer formed in a simple structure and made of an elastically deformable material in order to facilitate the coupling and separation of an overdenture was applied, and obtained a registration under Korean Utility Model Registration No. 20-0470574. However, in this ball-type attachment device, the retainer is made of an elasticity plastic material, and thus the external surface of the retainer is slightly pushed and returned to its original position in response to the mounting and demounting of the overdenture. When this is repeated, a resin, applied to the external surface of the retainer in order to bond and fasten the retainer to the overdenture, and the retainer are slightly separated from each other. Accordingly, there occurs a problem in which a foreign material is caught between the resin and the retainer or the retainer is separated from the overdenture and a problem in which the masticatory sensation of a user is reduced due to the unavoidably excessive elasticity of the retainer.

Meanwhile, in order to produce an overdenture to which ball-type attachments are applied (hereinafter simply referred to as the “overdenture”), it is natural that ball-type attachment-based implants, to which abutments can be coupled, have been placed in a recipient in advance and the gums of the recipient have been stabilized. An important point is that the angles, directions, depths, or the like at, in, to, or the like which the implants are placed are not made uniform due to the state and shape of the upper or low jaw bone of the recipient (a non-uniform implantation feature).

A conventional overdenture has been produced by the following method:

Of intermediate structures obtained during the process of producing an overdenture, a structure having the same phase (a positive shape) as gums of a recipient and an abutment is referred to as a model, and a structure having the opposite phase (a negative shape) is referred to as an impression.

\textcircled{1} Acquisition of impression: An impression is acquired from gums of a recipient by using a predetermined impression material (e.g., rubber, silicon or the like) in the state in which the impression coping of implant fixtures, or abutments and the impression copings of the abutments are mounted on the gums of the recipient. In this case, the impression copings of the fixtures or the impression copings of the abutments are contained inside the impression, and a negative recession is formed due to the impression copings (there is a case where the impression coping of a fixture is not contained in an impression and only forms a negative recession in the impression according to the type thereof). FIG. 8 shows an example of acquiring an impression in the state in which the abutments and the impression copings of the abutments have been mounted on the gums.

\textcircled{2} Formation of model: In a dental laboratory, fixture analogs or abutment analogs are inserted into the internal recessions of the impression copings inserted into the impression, and a working model is formed of an appropriate material (plaster or the like) by using the impression as a template. In this case, when only the fixture analogs have been inserted into the impression, the working model is formed in the state in which only the fixture analogs have been inserted, and thus the abutment analogs having the same height as that in the oral cavity is additionally attached to the impression. When the abutment analogs have been inserted into the impression, the working model is formed in the state in which the abutment analogs have been inserted.

\textcircled{3} Formation of wax denture: The mounting of an overdenture frame, the arrangement of teeth, and the formation of a wax denture are performed using the working model, into which the abutment analogs have been implanted, as a template according to a common method. Coupling recessions are formed by enlarging a space, into which the abutment analogs had been inserted, to an appropriate size so that retainers can be slightly comfortably inserted thereinto. The wax denture formed as described above is applied to the oral cavity of the recipient, and then accuracy checking and partial modification are performed.

\textcircled{4} Formation of pre-overdenture: Once the wax denture has been completed, a pre-overdenture (a structure in which retainers are not fitted into coupling recessions) is formed by replacing wax with resin according to a common method.

\textcircled{5} Completion of overdenture: The retainers are coupled to the abutments of the recipient, an appropriate amount of bonding agent is applied to the coupling recessions of the pre-overdenture, and the pre-overdenture is mounted in the oral cavity of the recipient or on the model when the bonding agent is slightly set so that the retainer is bonded and coupled to the coupling recessions of the pre-overdenture in an integrated manner, thereby completing an overdenture. Since the size and shape of the coupling recessions do not correspond to those of the retainers, it is impossible to bond and couple the retainers to the couplings recession first.

Meanwhile, according to this conventional technology, the angles and directions of placed implants are not uniform, and this is incorporated into the angles and directions of overdenture retainers. Accordingly, the coupling angles of implant attachment-overdenture retainer pairs are different from each other, and thus it is not easy to selectively insert and remove (attach and detach) the overdenture. Furthermore, a specific attachment-retainer pair is subjected to excessive pressure, and thus the implant is deformed, the uneven wear of the abutment occurs in the attachment, or the early wear of retainer plastic is caused over a long period of time.

Moreover, according to the conventional technology, the amount of bonding agent applied to bond and couple the retainers to the coupling recessions of the pre-overdenture cannot be accurately determined. Accordingly, when the amount of bonding agent is insufficient, the retainers are separated and bonding work is performed again. In contrast, when the amount of bonding agent is excessive, the attachments and the retainers adhere to each other or the overdenture and gums of the recipient adhere to each other, with the result that a long period of time is required and pain is caused so as to separate them.

### DISCLOSURE

### Technical Problem

An object of the present invention is to provide a ball-type attachment device which can keep an abutment and a retainer bonded using a fitting method while maintaining a ball-type structure without requiring the use of an O-ring and which can prevent the retainer and resin from being separated from each other despite repeated use.

Another object of the present invention is to provide a ball-type attachment device in which elasticity is provided by not only a physical property (a material's own elasticity) of a retainer but also the structure of the retainer, thereby preventing a masticatory sensation from being degraded due to excessive elasticity and also improving a mounting and demounting sensation or a snap sensation related to an overdenture.

Still another object of the present invention is to provide a ball-type attachment device in which a retainer includes a cushion part and a fastening part, which enables the cushion part to be easily inserted into the fastening part during the process of coupling the cushion part and the fastening part to each other, and which enables the cushion part to be stably fastened to the fastening part without being separated from the fastening part in the state in which one end of the cushion part has been inserted.

Still another object of the present invention is to provide a method which enables an overdenture, to which ball-type attachments are applied, to be stably and easily inserted and separated by making the angles and directions of overdenture retainers uniform, and which enables the overdenture to be accurately and rapidly produced.

### Technical Solution

According to the present invention, some of the above-described objects are achieved by a ball-type attachment device for an overdenture, the ball-type attachment device including an abutment configured such that a ball-shaped coupling protrusion is formed at the exposed distal end thereof, and a retainer configured to be separably fitted over the coupling protrusion by a fitting method, wherein the retainer includes: a cushion part made of an elastically deformable material, and configured such that a coupling recession having a shape corresponding to the ball shape of the coupling protrusion is formed therein so as to allow the coupling protrusion to be separably inserted and fitted into the cushion part; and a fastening part configured to be fastened to the overdenture, and configured such that an accommodation recession configured to accommodate the cushion part is formed therein so as to allow the cushion part to be inserted and fitted into the fastening part.

Furthermore, according to the present invention, some of the above-described objects are achieved by 11. A method of producing an overdenture to which ball-type attachments are applied, the method including: acquiring a negative impression from gums of a recipient; forming a positive working model, to which abutment analogs are fastened, by using the impression; fitting retainer analogs over abutment balls of the working model, and filling spaces between the retainer analogs and gums of the working model with a predetermined molding material and fixing the spaces in the state in which directions of all the retainer analogs have been made uniform; forming a wax denture by using the working model as a template, and modifying the wax denture; forming a pre-overdenture by replacing wax of the modified wax denture with resin (in which case a plurality of retainer coupling recessions have been formed in the pre-overdenture); and inserting and bonding retainers into the coupling recessions of the pre-overdenture, wherein an appropriate amount of adhesive is applied to the coupling recessions of the pre-overdenture formed by the retainer analogs and the retainers are bonded into the coupling recessions of the pre-overdenture, thereby completing an overdenture.

### Advantageous Effects

In accordance with the ball-type attachment device for an overdenture according to the present invention, the retainer is configured to have a dual material and a dual structure including the elastic material part and the inelastic material part. Accordingly, the abutment and the retainer are coupled and maintained using a fitting method without requiring an O-ring, and thus the advantage of omitting an O-ring part is achieved and the retainer and the resin can be prevented from being separated despite repeated use. The attachment and separation of the overdenture are facilitated without degrading a masticatory sensation. Moreover, even when an elasticity reduction phenomenon attributable to repeated use occurs, the overall retainer does not need to be replaced, but only the elastic material part of the retainer can be simply replaced, thereby providing the convenience of the maintenance of the overdenture.

Furthermore, in accordance with the ball-type attachment device for an overdenture according to the present invention, the fastening protrusion having a structure in which one or more parts are eliminated or open is formed on the fastening part of the retainer, so that the retainer is configured to include the cushion part and the fastening part, the cushion part can be easily inserted into the fastening part during the process of coupling them, and the cushion part can be stably fastened into the fastening part without being separated from the fastening part in the state in which one end of the cushion part has been inserted.

Furthermore, in accordance with the method of producing an overdenture according to the present invention, an overdenture is produced with the directions of all retainers made uniform, so that the insertion and separation of the overdenture are facilitated, and so that the attachment-retainer pairs are subjected to uniform pressure, thereby preventing the deformation of the implants, the uneven wear of the abutments in the attachments, and the early wear of retainer plastic.

Moreover, in accordance with the method of producing an overdenture according to the present invention, the coupling recessions are formed to accurately meet the sizes of the retainers during the production of an overdenture, and thus the retainers can be inserted and bonded by applying an appropriate amount of adhesive (bonding agent), thereby preventing additional work or time consumption which may occur due to the inappropriateness of the amount of adhesive.

### DESCRIPTION OF DRAWINGS

FIG. 1 is a perspective view showing an example of an implant-supported overdenture;

FIG. 2 is a perspective view showing a ball-type attachment device for an overdenture according to an embodiment of the present invention, with a portion of a retainer fitted over an abutment being cut away;

FIG. 3 shows a perspective view and side view of the cushion part of the retainer in the ball-type attachment device for an overdenture shown in FIG. 2;

FIG. 4 shows partially cutaway perspective views of the fastening part of the retainer in the ball-type attachment device for an overdenture shown in FIG. 2;

FIG. 5 shows views illustrating the process in which the cushion part of the retainer is inserted into the fastening part of the retainer in the ball-type attachment device for an overdenture shown in FIG. 2;

FIG. 6 is a schematic diagram illustrating the fitting relationship and structure between the cushion part of the retainer and the coupling protrusion of the abutment in the present invention;

FIG. 7 is a partially cutaway perspective view showing the state in which the cushion part and fastening part of the retainer have been coupled into each other, in the ball-type attachment device for an overdenture shown in FIG. 2;

FIG. 8 is a photo view showing the process of acquiring an impression according to an example of a conventional technology;

FIG. 9 is a photo view showing an example of the process of producing an overdenture to which ball-type attachments are applied according to the present invention;

FIG. 10 is a photo view showing an example of fitting and fastening a retainer analog into an abutment ball of a working model in a method of producing an overdenture to which ball-type attachments are applied according to the present invention; and

FIG. 11 is a photo view showing an example in which retainer coupling recessions have been formed in a pre-overdenture in the method of producing an overdenture to which ball-type attachments are applied according to the present invention.

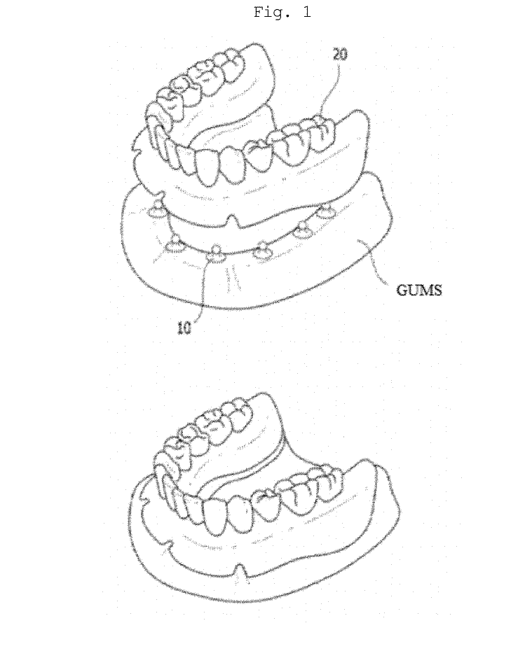

### MODE FOR INVENTION

In order to fully understand the present invention, the operating advantages of the present invention, and objects achieved by the practice of the present invention, reference should be made to the accompanying drawings illustrating preferred embodiments of the present invention and descriptions given in the accompanying drawings.

The present invention will be described in detail below by describing the preferred embodiments of the present invention with reference to the accompanying drawings. However, in the description of the present invention, a description of a well-known function or configuration will be omitted in order to make the gist of the present invention clear.

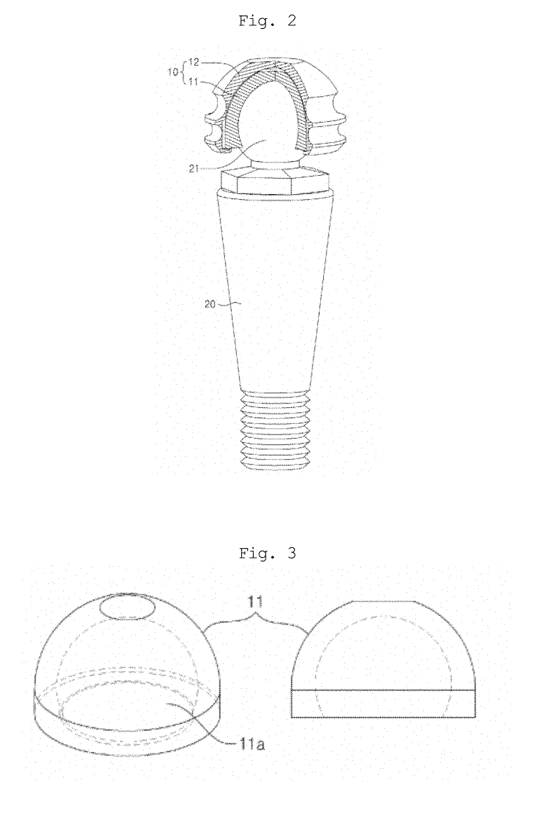

Referring to FIG. 2, a ball-type attachment device for an overdenture according to the present invention is applied to an implant-supported overdenture, and includes an abutment 20 configured to be inserted into gums of a patient and a retainer 10 configured to be fitted and maintained over the abutment 20 by a fitting method in the state of being fastened into an overdenture.

The abutment 20 functions to stably support an overdenture worn on a patient's gums, and is generally made of a metallic material, such as stainless steel (SUS), titanium, or the like. In this case, the abutment 20 may be applied in the configuration of being inserted into gums of a patient and engaged with a fixture implanted into the patient's alveolar bone, or in the configuration of being integrated with a fixture. For reference, the abutment 20 shown in FIG. 2 is of a type in which the abutment 20 and a fixture are integrated into a single body.

Referring to FIG. 2, the abutment 20 includes a ball-shaped coupling protrusion 21 formed at the exposed distal end (upper end) thereof. In this case, the abutment 20 is implanted into gums so that the ball-shaped coupling protrusion 21 is exposed to the outside. The abutment 20 according to the present invention is not limited to a specific shape or structure as long as the “ball-shaped coupling protrusion 21 is formed on the exposed distal end.”

The retainer 10 is fitted over the coupling protrusion 21 of the abutment 20 by a fitting method upon wearing of an overdenture, as in a snap fastener, in the state of being fastened into the overdenture by adhesive resin or the like.

Referring to FIGS. 2 to 5, the retainer 10 includes a cushion part 11 made of an elastic material, and a fastening part 12 made of an inelastic material. In other words, the retainer 10 according to the present invention is characterized by being provided to have a dual material and a dual structure including the elastic material part and the inelastic material part in the ball-type attachment device for an overdenture. For reference, the retainer 10 is fastened to the overdenture such that the inside of the cushion part 11 is exposed in the state in which the cushion part 11 has been coupled to the fastening part 12.

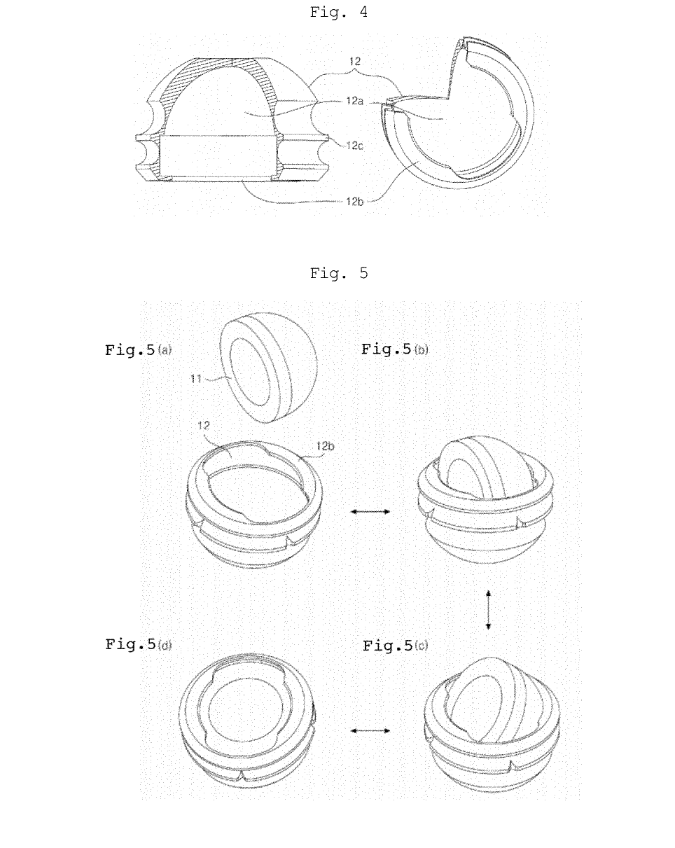

As shown in FIG. 3, the cushion part 11 of the retainer 10 includes a coupling recession 11a corresponding to the ball shape of the coupling protrusion 21 so that the ball-shaped coupling protrusion 21 of the abutment 20 is separably inserted and fastened into the inside of the cushion part 11. Meanwhile, as shown in FIG. 5, the cushion part 11 of the retainer 10 is inserted and fastened into the inside of the fastening part 12 of the retainer 10, which will be described later. For this purpose, the outside of the cushion part 11 of the retainer 10 is formed to have a shape corresponding to the accommodation recession 12a of the fastening part 12 of the retainer 10. Although it is sufficient if the external shape of the cushion part 11 and the corresponding internal shape of the fastening part 12, i.e., the shape of the accommodation recession 12a, correspond to each other, it is preferred that they are a protruding hemispherical shape and a corresponding recessed hemispherical shape, respectively, as shown in FIGS. 3 and 4, so that the cushion part 11 is inserted and fitted into the fastening part 12 in any direction.

The cushion part 11 of the retainer 10 according to the present invention is characterized by being made of an elastically deformable material in order to simplify a fitting structure and facilitate fitting and separation when being fitted and maintained over the coupling protrusion 21 of the abutment 20 by a fitting method. In this case, although the “elastically deformable material” is preferably a plastic material, the “elastically deformable material” does not exclude a metallic material.

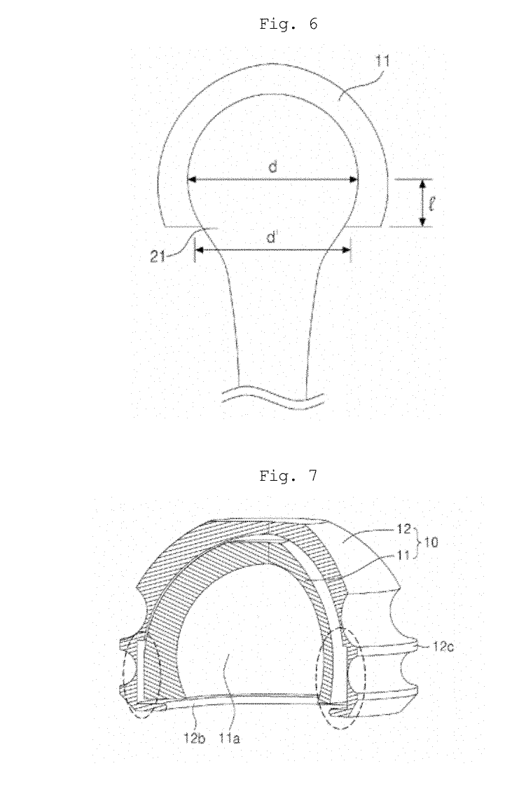

Meanwhile, a half or more portion of the ball of the coupling protrusion 21 of the abutment 20 is preferably inserted into the inside of the cushion part 11 of the retainer 10, and thus the coupling recession 11a of the cushion part 11, into which the coupling protrusion 21 of the abutment 20 is inserted and accommodated, is preferably formed to have an approximately recessed hemispherical shape (For reference, if the shape of the coupling recession 11a is a protruding exact hemisphere, only an exact half of the ball of the coupling protrusion 21 is inserted. In order to allow a half or more portion of the ball to be inserted, the shape needs to be an intermediate shape between a recessed “hemisphere” and a recessed “sphere” in practice. Accordingly, the term “approximately” is used to represent the shape). In other words, as shown in FIG. 6, the coupling recession 11a is formed such that when the coupling protrusion 21 of the abutment 20 is inserted into the inside of the cushion part 11 of the retainer 10, a plane in which the largest diameter of the ball of the coupling protrusion 21 is located inside the entrance of the coupling recession 11a. As a result, the entrance diameter d′ of the coupling recession 11a is preferably smaller than the largest diameter d of the coupling protrusion 21. This can prevent the coupling protrusion 21 of the abutment 20 from being separated from the coupling recession 11a of the retainer 10 and can maintain stable coupling force (unless a user intentionally pulls the coupling protrusion 21 of the abutment 20 in order to remove the overdenture). Meanwhile, although the largest diameter of the coupling protrusion 21 is substantially the same as the largest diameter d of the coupling recession 11a and thus the entrance diameter d′ of the coupling recession 11a is smaller than the largest diameter of the coupling protrusion 21, the entrance of the coupling recession 11a is slightly extended and then contracted while the coupling protrusion 21 is being inserted into the coupling recession 11a because the cushion part 11 of the retainer 10 is made of an elastically deformable material. Accordingly, the coupling protrusion 21 is selectively fitted into and separated from the coupling recession 11a by a fitting method while providing a snap sensation.

As shown in FIGS. 2, 4, 5 and 7, the fastening part 12 of the retainer 10 includes the accommodation recession 12a formed to have a shape corresponding to the external shape of the cushion part 11 so that the cushion part 11 of the retainer 10 is inserted and fitted into the fastening part 12 of the retainer 10. Furthermore, the external surface of the fastening part 12 of the retainer 10 is fastened to an overdenture by adhesive resin or the like. In this case, the external surface of the fastening part 12 of the retainer 10 preferably has an approximately protruding hemispherical shape and is preferably provided with a protrusion 12c, as partially shown in FIG. 4, in order to enable the retainer 10 to be coupled to the overdenture in various directions or at various angles and also increase the bonding and fastening force between the retainer 10 and the overdenture while rarely influencing the thickness of the overdenture.

Furthermore, as shown in FIGS. 4, 5 and 7, the fastening part 12 of the retainer 10 includes a fastening protrusion 12b configured to prevent the inserted cushion part 11 from being separated and formed on the inner circumferential surface of the exposed distal end of the accommodation recession 12a. In this case, it is preferred that the fastening protrusion 12b is not continuously formed along the overall inner circumferential surface of the exposed distal end but is provided in a structure in which one or more portions are eliminated or open, as shown in FIG. 5 (for reference, the eliminated or open portions are referred to as the “open portions” hereinafter). More preferably, the open portions are a pair of open portions on both opposite sides. Accordingly, the cushion part 11 can be easily inserted into the accommodation recession 12a of the fastening part 12 via the open portions without requiring excessive force, and also can be prevented from being separated by the fastening protrusion 12b of the fastening part 12 once the cushion part 11 has been inserted. Furthermore, although the open portions in which the fastening protrusion 12b is not present in the fastening part 12 may have an open area sufficient to allow the cushion part 11 to be inserted, the open portions preferably have a minimum area required for the insertion of the cushion part 11 in order to more stably fasten the inserted cushion part 11.

Referring to FIG. 5, the process of assembling the retainer 10, i.e., the process in which the cushion part 11 is inserted into the fastening part 12, is described below. First, as shown in FIG. 5(a), since the open portions in which parts of the fastening protrusion 12b have been eliminated are present, the cushion part 11 is tilted such that the cushion part 11 can be completely inserted through a portion having an enlarged open area. In this case, the angle at which the cushion part 11 is inserted is appropriately adjusted based on the sizes of the open portions in which parts of the fastening protrusion 12b have been eliminated. Thereafter, as shown in FIG. 5(b), the cushion part 11 in a tilted state is partially inserted into the accommodation recession 12a of the fastening part 12. Thereafter, as shown in FIG. 5(c), the remaining portion of the cushion part 11 protruding from the fastening part 12 to the outside is completely inserted into the accommodation recession 12a of the fastening part 12, as shown in FIG. 5(d), by rotating the cushion part 11 (see FIG. 6).

By the configurations of the cushion part 11 and fastening part 12 of the retainer 10, a case where the location of the fastening part 12 itself fastened to an overdenture is changed or the surface of the cushion part 11 is damaged due to the application of excessive force in the process of assembling the retainer 10, i.e., the process of inserting and fastening the cushion part 11 into the fastening part 12, can be prevented from occurring.

Meanwhile, the fastening part 12 of the retainer 10 is preferably made of a hard metallic material or plastic material having little elasticity and high hardness in order to prevent the fastening part 12 from being replaced due to a problem, such as abrasion or the like, within the life span of an overdenture.

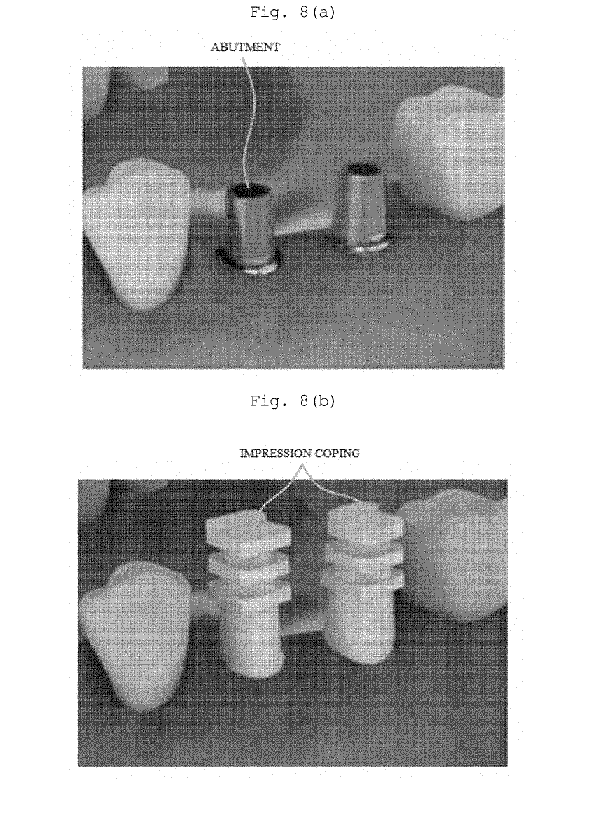

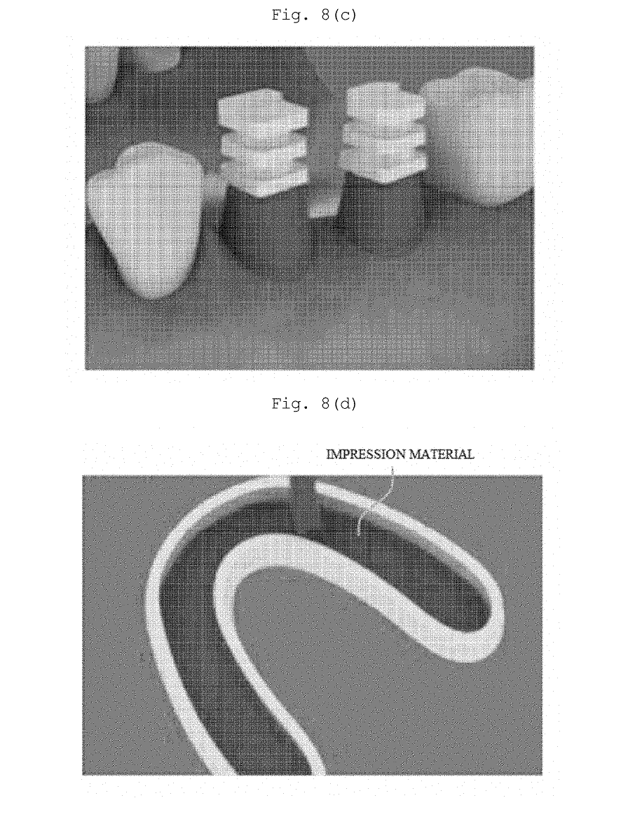

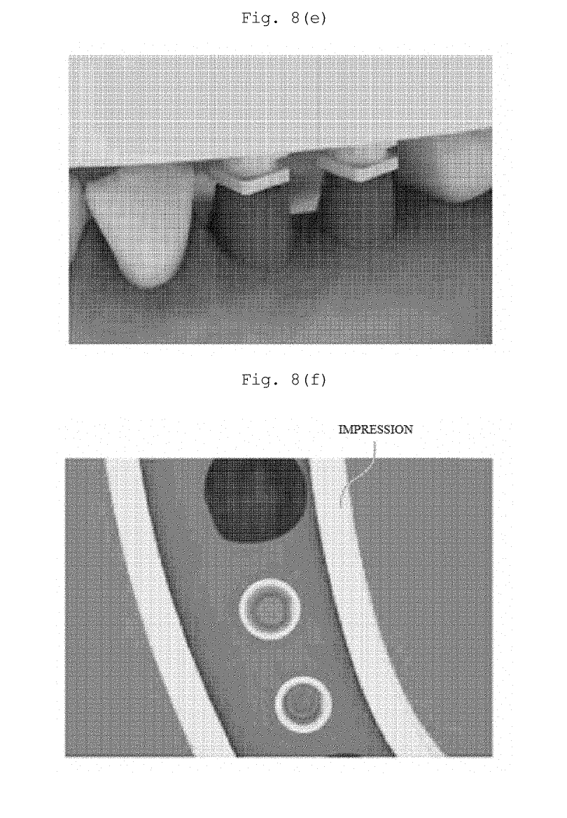

The retainer 10 according to the present invention pursues the ease of fitting and separation through the application of the cushion part 12, made of an elastically deformable material, to coupling with the coupling protrusion 21 of the abutment 20 based on a fitting method. However, coupling with and separation from the coupling protrusion 21 of the abutment 20 are performed in the state in which the cushion part 12 made of an elastic material has been accommodated and confined inside the hard fastening part 11 made of a metallic material or the like. Accordingly, the elasticity of the cushion part 12 is not sufficiently utilized, and thus excessive force is applied to separate the overdenture, with the result that inconvenience may be caused. In order to prevent such inconvenience from being caused, in the retainer 10 according to the present invention, the cushion part 11 and the fastening part 12 preferably have a predetermined gap between the opposite surfaces thereof near the exposed distal end (entrance) of the retainer 10. Due to the formation of the gap, when the coupling protrusion 21 of the abutment 20 is inserted into the entrance of the coupling recession 11a of the cushion part 11, the entrance of the coupling recession 11a can be elasticity pushed to the outside, and thus the elasticity of the cushion part 12 can be sufficiently utilized during the process of coupling the abutment 20 and the retainer 10 each other. Meanwhile, although a gap (portions represented by the dotted lines in FIG. 8) is formed by enlarging the portion of the fastening part 12 near the entrance thereof slightly more than the portion of the cushion part 11 near the entrance thereof in the example shown in FIG. 8, a gap may be formed by making the exposed distal end of the cushion part 11 thinner than the remaining portion of the cushion part 11.

Another method of enhancing the elasticity of the cushion part 11 of the retainer 10 is to impart more elasticity to the outside end of the cushion part 11 opposite to the entrance thereof, i.e., the distal end of the external protruding hemisphere by cutting a portion of the end, for example, in a horizontal direction, as shown in FIGS. 3 and 7. In this case, when the coupling protrusion 21 of the abutment 20 is inserted into the entrance of the coupling recession 11a of the cushion part 11, the entrance portion of the coupling recession 11a is elastically pushed to an upward direction toward the thin end and returned. Accordingly, the coupling protrusion 21 can be easily fitted and separately, and sufficient coupling force can be maintained when the coupling protrusion 21 has been coupled.

A method of producing an overdenture to which ball-type attachments are applied according to the present invention is described with reference to FIGS. 8 to 11.

In the present invention, the term “fixture analog” or “abutment analog” refer to an “analog” which has the same size and shape as the fixture or abutment of an implant or whose at least the portion exposed from gums to the outside has the same size and shape as the corresponding portion of the fixture or abutment of an implant. The size and shape of the portion not exposed to the outside may be determined as desired, and the material of the portion may be selected from among various materials.

In the present invention, the term “retainer analog” refers to an analog which can be selectively fitted into and separated from an abutment ball, like a retainer, whose appearance is similar to that of a retainer and has no curve, and whose appearance size is somewhat larger than that of the retainer in the strict sense.

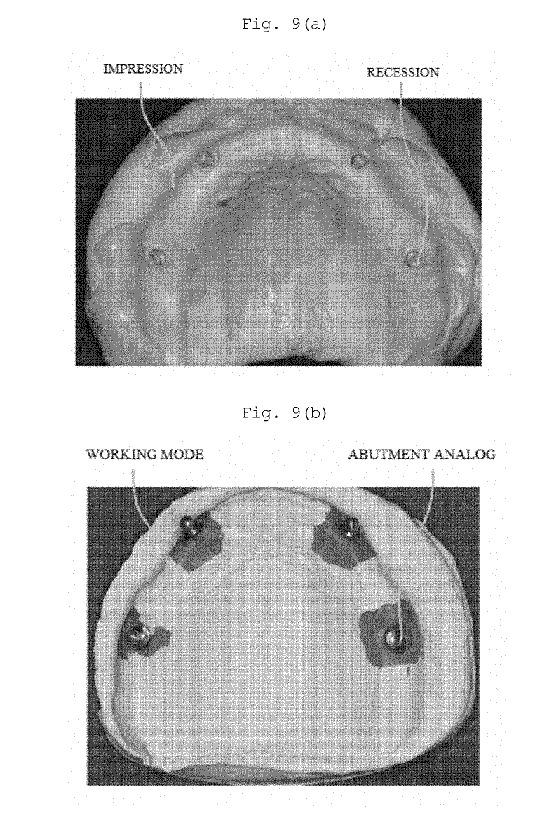

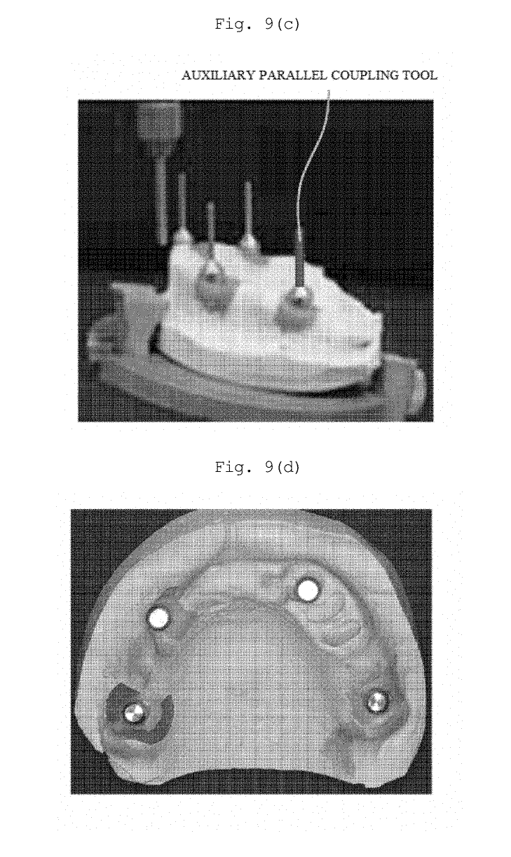

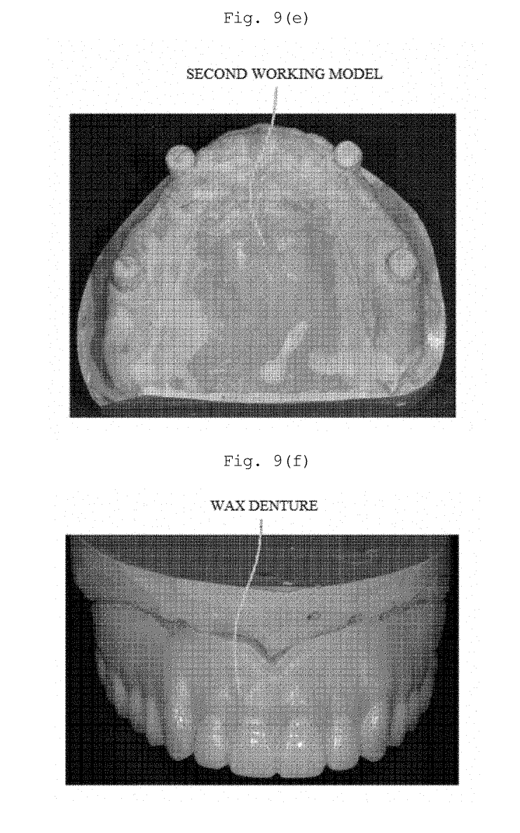

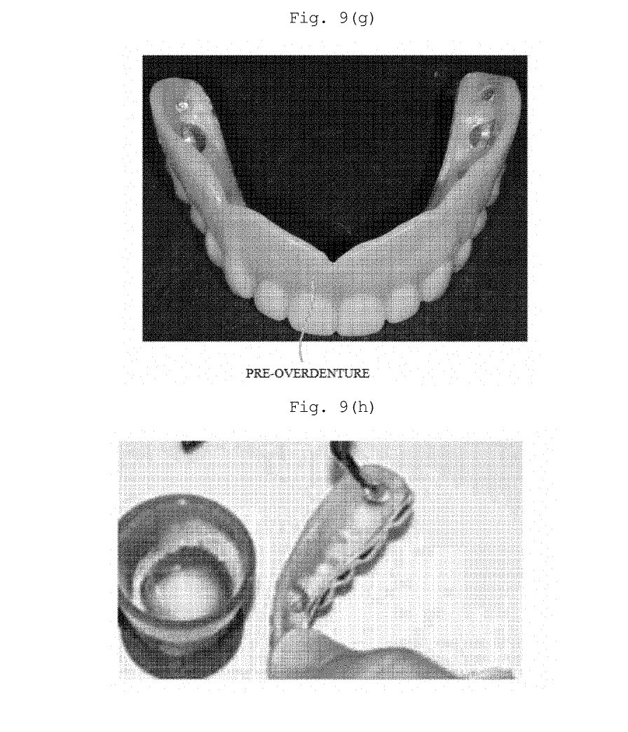

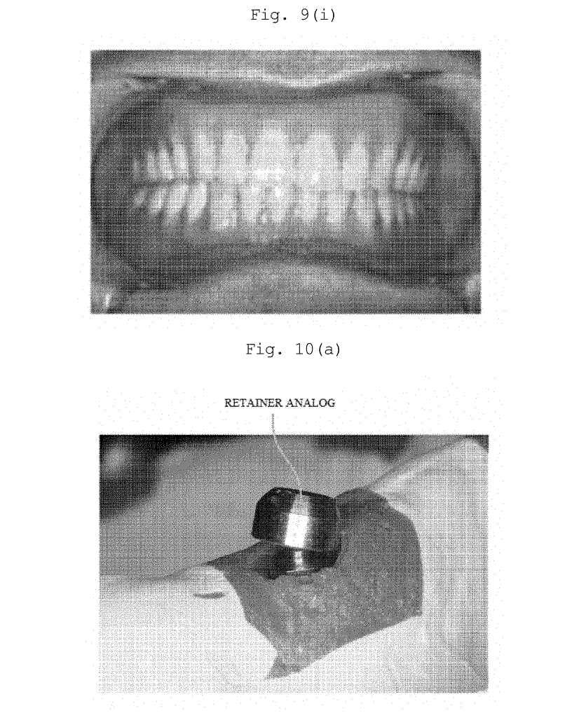

As described above, the present invention relates to a method of producing an overdenture to which ball-type attachments are applied, which includes the steps of: (A) acquiring a negative impression from gums of a recipient; (B) forming a positive working model, to which abutment analogs are fastened, by using the impression; (C) forming a wax denture by using the working model as a template, and modifying the wax denture; (D) forming a pre-overdenture by replacing the wax of the modified wax denture with resin (in which case a plurality of retainer coupling recessions have been formed in the pre-overdenture); and (E) completing an overdenture by inserting and bonding retainers into the coupling recessions of the pre-overdenture. In FIG. 9, photos showing an example of the process of producing an overdenture to which ball-type attachments are applied according to the present invention are attached. Although the formation of a second working model is also shown in the illustrated example (see FIG. 9(e)), the formation of the second working model may be omitted.

Before the impression is acquired at step (A), the gums of the recipient have been stabilized because the wounds attributable to implantation have healed up, and impression copings of one or more implant fixtures, or abutments and the impression copings of the abutments have been mounted. Once the impression has been acquired, fixtures or the impression copings of abutments are inserted into the inside of the impression, and negative recessions are formed in the impression by the impression copings (see FIG. 9(a)).

Thereafter, the positive working model is formed using the impression at step (B) (see FIG. 9(b)). As described in the background art section, fixture analogs or abutment analogs are inserted into the internal recessions of the impression copings inserted into the impression, and the working model is formed of a material, such as plaster or the like by using the impression as a template. In this case, the abutment analogs have been fastened to the working model.

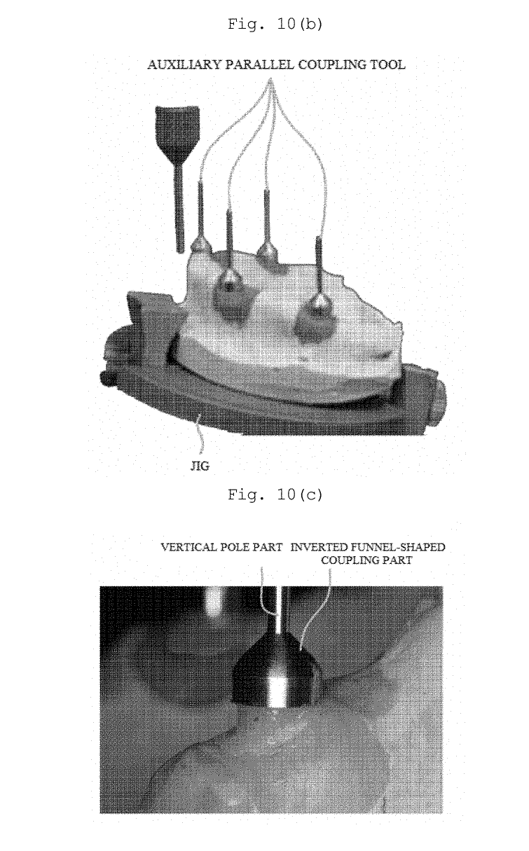

Meanwhile, although not considered in the conventional technology, the attachment and detachment of the overdenture can be smoothly performed, a snap sensation can be provided, and resistance and pressure can be uniformly distributed during the attachment and detachment of the overdenture and mastication, only when the directions of insertion and separation and the directions of the retainers are uniform in the completed overdenture. Accordingly, according to the present invention, in order to make the directions of the retainers uniform, when the working model into which the abutment analogs have been inserted is prepared before the step of forming the wax denture (between step (B) and step (C)), step (F) of mounting retainer analogs on the abutment balls of the working model and fixing uniform directions is performed (see FIG. 9(c)). In FIG. 10, photos showing an example of the process of making the directions of the retainer analogs uniform are attached. In the state in which the working model has been placed on a predetermined jig, the retainer analogs are mounted, the directions of the retainer analogs are made uniform (see FIG. 10(a)), and the spaces between the retainer analogs and the gums of the working model are filled with a predetermined molding material, such as wax or the like, and then are fixed (see FIG. 10(d)). A photo of an example of this state is FIG. 9(d).

In the present invention, the directions of the retainer analogs may be made uniform by using various tools and methods. For example, “auxiliary parallel coupling tools” may be placed on the retainer analogs, and then the directions of the retainer analogs may be made uniform.

As an example, each of the auxiliary parallel coupling tool may include an inverted funnel-shaped coupling part configured to receive an external surface of a corresponding one of the retainer analogs, and a vertical pole part (a parallel pin). The process of mounting and fastening retainer analogs on and to a working model by using the above auxiliary parallel coupling tools is as follows. First, the inverted funnel-shaped coupling parts are inserted over the external surfaces of retainer analogs, directions are adjusted such that all the vertical pole parts are parallel (see FIG. 10(b)), and the spaces between the bottom ends of the inverted funnel-shaped coupling parts and the gums of the working model are fix using a predetermined molding material (see FIG. 10(c)). Thereafter, the auxiliary parallel coupling tools are removed, the spaces between the retainer analogs and the gums of the working model are trimmed, and the retainer analogs are fastened (see FIG. 10(d)).

As another example, each of the auxiliary parallel coupling tools may include a magnet part configured to be coupled to a top surface of a corresponding one of the retainer analogs, and a vertical pole part (a parallel pin) (not shown). When this type of auxiliary parallel coupling tools are used, the magnet parts are attached to the top surfaces of retainer analogs, and then the retainer analogs are fastened using a method identical to the above-described method.

Once the working model to which the retainer analogs are fastened has been completed, the wax denture is formed using the working model as a template at step (C) (see FIGS. 9(d) and 9(f)). If a soft material, such as wax, was used as the molding material when the retainer analogs was fastened to the working model, portions to which the retainer analogs have been fastened may be deformed when the wax denture is formed. Accordingly, in order to mitigate this, step (G) of acquiring a negative second impression from the working model of step (F) and step (H) of forming a positive second working model made of a hard material, such as plaster or the like, by using the second impression may be performed before step (C), and then the wax denture may be formed by using the second working model as a template. A photo showing an example of the second working model is attached in FIG. 9(e).

The wax denture is formed, for example, in the sequence in which an overdenture frame is formed using working model (or the second working model) and then teeth are arranged, as in a common method. After the wax denture has been formed, the wax denture is tentatively applied to the recipient, and then accuracy checking and partial modification are performed.

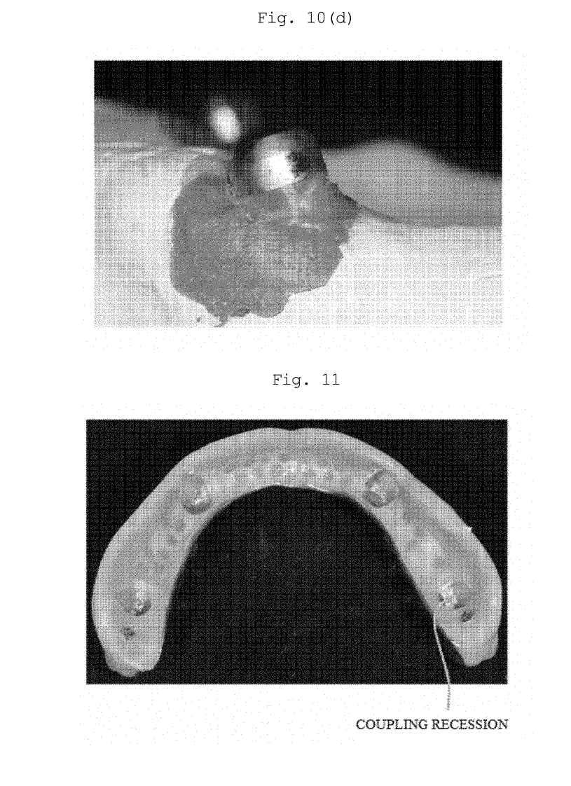

Thereafter, the pre-overdenture is formed by replacing the wax of the modified wax denture with, for example, resin according to a common method at step (D) (see FIG. 9(g)). In this case, the plurality of retainer coupling recessions formed in the wax denture due to the retainer analogs of the working model from step (C) have been formed in the pre-overdenture (see FIG. 11).

Finally, an overdenture is completed by inserting and bonding retainers into the coupling recessions of the pre-overdenture at step (E) (see FIGS. 9(h) and 9(i)). Since the size of the coupling recessions is the same as that of the external surfaces of the retainer analogs and the size and shape of the external surfaces of the retainer analogs are approximately the same as (actually, slightly larger than; as in a situation in which the size of the insides of shoes is slightly different from that of feet) those of the external surfaces of the retainers, the retainers are inserted after applying a predetermined accurate amount of adhesive without a need to additionally enlarge the coupling recessions. In this case, the directions of the retainer analogs have been made uniform in advance, and thus the directions of the retainers have been inserted are naturally uniform. The retainers are allowed to be fastened by mounting the pre-overdenture on the gums of the recipient or the working model before the inserted retainers are completely set.

The present invention is not limited to the above-described embodiments, and it will be apparent to those having ordinary knowledge in the art that various modifications and alterations can be made without departing from the spirit and scope of the present invention. Accordingly, such modifications and alterations should be construed as falling within the claims of the present invention.

### INDUSTRIAL APPLICABILITY

The present invention is applicable to industries related to an attachment device used for the procedure of an implant-supported overdenture and a method of producing an overdenture to which the attachment device is applied.

1. A ball-type attachment device for an overdenture, the ball-type attachment device for the overdenture relates to an attachment device for implant-supporting overdentures, which includes an abutment configured such that a ball-shaped coupling protrusion is formed at an exposed distal end thereof, and a retainer configured to be separably fitted over the coupling protrusion by a fitting method,
wherein the retainer comprises:
a cushion part made of an elastically deformable material, and configured such that a coupling recession having a shape corresponding to a ball shape of the coupling protrusion is formed therein so as to allow the coupling protrusion to be separably inserted and fitted into the cushion part; and
a fastening part configured to be fastened to the overdenture, and configured such that an accommodation recession configured to accommodate the cushion part is formed therein so as to allow the cushion part to be inserted and fitted into the fastening part.

2. The ball-type attachment device of claim 1, wherein the coupling recession of the cushion part has an approximately recessed hemispherical shape, and an entrance diameter of the coupling recession is smaller than a largest diameter of a ball of the coupling protrusion.

3. The ball-type attachment device of claim 1, wherein the fastening part has a fastening protrusion formed on an inner circumferential surface of an exposed distal end of the accommodation recession so as to prevent the inserted and fitted cushion part from being separated.

4. The ball-type attachment device of claim 3, wherein the fastening protrusion is provided in a structure in which the fastening protrusion is not continuously formed along the entire inner circumferential surface of the exposed distal end of the accommodation recession and a part of the fastening protrusion are eliminated.

5. The ball-type attachment device of claim 4, wherein the parts in which the fastening protrusion is not present in the fastening part are a pair of parts on both opposite sides.

6. The ball-type attachment device of claim 4, wherein the cushion part is partially inserted into the accommodation recession in an inclined state through the parts in which the fastening protrusion is not present, and, then, is completely inserted into the accommodation recession by rotation.

7. The ball-type attachment device of claim 1, wherein a predetermined gap is formed between opposite surfaces of the cushion part and the fastening part near exposed distal ends thereof so as to allow elasticity of the cushion part to be sufficiently generated during a process of coupling the abutment and the retainer to each other.

8. The ball-type attachment device of claim 7, wherein the predetermined gap is formed by enlarging a portion of the fastening part near an entrance thereof slightly more than a portion of the cushion part near an entrance thereof or by making the exposed distal end of the cushion part thinner than a remaining portion of the cushion part.

9. The ball-type attachment device of claim 1, wherein the cushion part is configured such that an outside end thereof opposite to the entrance thereof is cut in a horizontal direction.

10. The ball-type attachment device of claim 1, wherein the fastening part is made of a metallic material.

11. A method of producing an overdenture to which ball-type attachments are applied, the method comprising:
acquiring a negative impression from gums of a recipient;
forming a positive working model, to which abutment analogs are fastened, by using the impression;
fitting retainer analogs over abutment balls of the working model, and filling spaces between the retainer analogs and gums of the working model with a predetermined molding material and fixing the spaces in a state in which directions of all the retainer analogs have been made uniform;
forming a wax denture by using the working model as a template, and modifying the wax denture;
forming a pre-overdenture by replacing wax of the modified wax denture with resin (in which case a plurality of retainer coupling recessions have been formed in the pre-overdenture); and
inserting and bonding retainers into the coupling recessions of the pre-overdenture, wherein an appropriate amount of adhesive is applied to the coupling recessions of the pre-overdenture formed by the retainer analogs and the retainers are bonded into the coupling recessions of the pre-overdenture, thereby completing an overdenture.

12. The method of claim 11, wherein upon filling spaces between the retainer analogs and the gums of the working model with a predetermined molding material and fixing the spaces, auxiliary parallel coupling tools are placed on the retainer analogs, and the directions of the retainer analogs are made uniform by using the auxiliary parallel coupling tools.

13. The method of claim 12, wherein each of the auxiliary parallel coupling tools comprises an inverted funnel-shaped coupling part configured to receive an external surface of a corresponding one of the retainer analogs, and a vertical pole part (a parallel pin).

14. The method of claim 12, wherein each of the auxiliary parallel coupling tools comprises a magnet part configured to be coupled to a top surface of a corresponding one of the retainer analogs, and a vertical pole part (a parallel pin).

15. The method of claim 11, further comprising, after filling spaces between the retainer analogs and the gums of the working model with a predetermined molding material and fixing the spaces and before forming and modifying the wax denture,
acquiring a negative second impression from the working model; and
forming a positive second working model by using the second impression;
wherein the working model used for forming and modifying the wax denture is replaced with the second working model.
